(19) United States
(12) Patent Application Publication
(10) Pub. No.: US 2006/0020687 A1
(43) Pub. Date: Jan. 26, 2006

(54) Remote recording of data transmission

(76) Inventor: Marvin Blumberg, Bethesda, MD (US)

Correspondence Address: JACOBSON HOLMAN;PROFESSIONAL LIMITED LIABILITY COMPANY, 400 SEVENTH STREET, N. W., WASHINGTON, DC, 20004, US

(21) Appl. No.: 11/186,922

(22) Filed: Jul. 22, 2005

Related U.S. Application Data
(60) Provisional application No. 60/590,371, filed on Jul. 23, 2004.

(51) Int. Cl. G06F 15/16

(52) U.S. Cl. 709/219

(57) ABSTRACT

A data center includes a recorder/transmitter device and offers the benefits of: protection against viruses transmitted through the internet, facilitates payment by the user for the right to record material protected by copyright, facilitates accessing a library of material that may or may not be protected by copyrights, makes the program which the user uses to control the recorder/transmitter simpler, and makes it easier for many users to do such things as increasing amount of available memory of the recorder/transmitter device, maintaining and upgrading the recorder/transmitter device and its software and a faster recovery method for its replacement if it malfunctions. The service provided at the data center would include monitoring the recording, transmitter device and software so that a malfunction is immediately realized when it occurs and replacement of equipment is implemented.

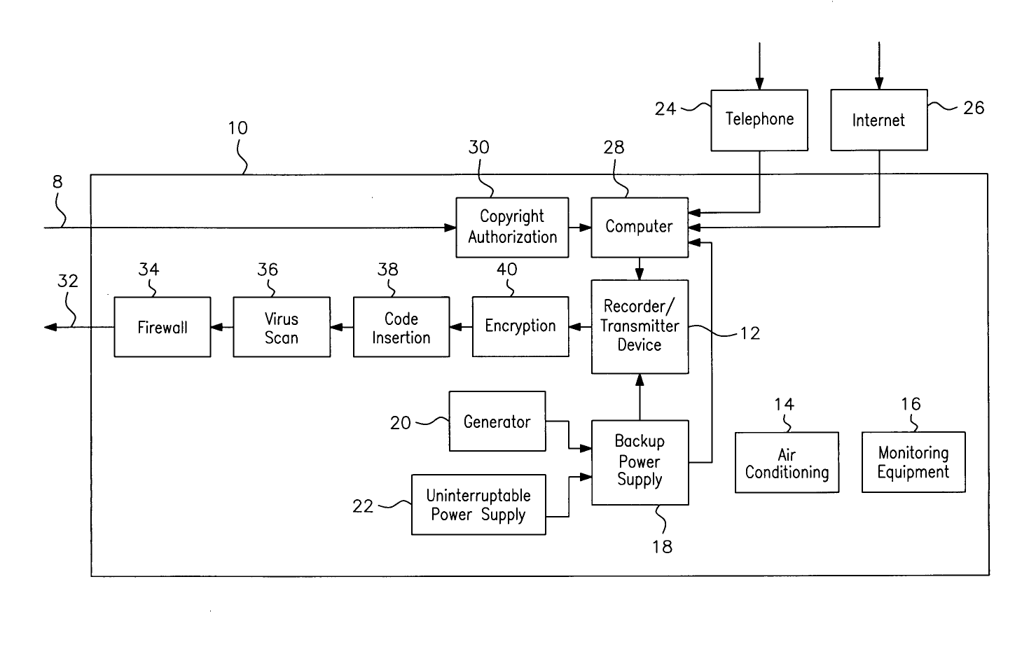

This is a complete application claiming benefit of provisional application Ser. No. 60/590,371, filed Jul. 23, 2004.

### FIELD OF THE INVENTION

The present invention relates to the field of remote storage of data for copyright protected material. Authorization for release of data is obtained from the copyright owner and the data is then transferred to the remote storage unit for continuously available access by the licensed user.

### BACKGROUND OF THE INVENTION

At the present time, a recording can be made of data or a movie transmitted to a person by the use of a recording device in the home of the person. This can be done for data, music, or movies which are broadcast, or music and movies which have been previously recorded on compact disk, tape or cassette. Copyright laws are frequently broken by such recordings due to copying without the permission of the author.

### SUMMARY OF THE INVENTION

One purpose of the method of the present invention is to provide more protection to material protected by copyright. The method described here places the recording device for recording of a transmission in a location remote from the user's home or office. Such a location is preferably a building designed for the purpose of supporting computer servers. Such buildings are called data centers.

In addition, the data center offers other benefits such as: protection against viruses transmitted through the internet, facilitates payment by the user for the right to record material protected by copyright, facilitates accessing a library of material that may or may not be protected by copyrights, makes the program which the user uses to control the recorder/transmitter simpler, and makes it easier for many users to do such things as increasing amount of available memory of the recorder/transmitter device (RTD), maintaining and upgrading the recorder/transmitter device and its software and a faster recovery method for its replacement if it malfunctions. The service provided at the data center would include monitoring the recording, transmitter device and software so that a malfunction is immediately realized when it occurs and replacement of equipment is implemented.

The above benefits can be achieved by the individual user being the sole owner of a recorder/transmitter device or owning a section of memory on a recorder/transmitter device, e.g. a blade or part of a blade in a computer server. The user could also lease the RTD or a section of the memory on the RTD. If the RTD is located in a building (such as a data center) serving many customers and which is remote from the user's home, the equipment and personnel cost required can be shared.

A building with an uninterruptible power supply system which provides power if there is an interruption of the utility power would be especially advantageous to the user. The place where the recorder/transmitter device is located, would preferably have the equipment which is typically included in a data center, i.e., backup power supply equipment which includes generators and uninterruptible power supply equipment with batteries, and sufficient air conditioning equipment to keep the critical load contained in the data center building at the proper temperature. Also, the data center building would have monitoring equipment which would give information of any malfunction in the electrical-power equipment, the air conditioning equipment and computer equipment used to send and receive data through the internet.

Data sent by the RTD to the user's home or office will have the additional protection against viruses which is provided by the equipment in the data center where “fire wall” protection would be available.

The data sent by the RTD to the user's home would preferably be encrypted by the owner of the copyright. The data center could also encrypt data which is sent from the data center to the internet. The encryption may include a program which would cause the data that is stored or transmitted to be erased, that is, eliminated, or scrambled so that it cannot be used again once displayed or after it is used more than a predetermined number of times that has been agreed to by the copyright owner.

Also, the data center could include in the programming of the RTD a method of inserting a code on data which would identify the RTD which processed the data. If a user received the data, copied it, and then transmitted it, the copies would reveal from which RTD the data was sent. Such a code could also be displayed in a hard to discover manner on the data transmitted for a movie. If the movie was displayed by the user and someone copied the display with a video camera, the hidden code on the copy could lead back to the particular RTD and identify the original recipient of data from the RTD and provide a lead for tracking down an unauthorized receiver of data.

The recipient of the data from the RTD would have control of the RTD from their home station. The user would start or stop or rewind or go fast forward or change to other recorded data. All this would be controlled by a hand held remote control communicating with a set top box or other infrared receiving device connected by an internet connection or hard wire by phone communications to the remotely located RTD.

The recipient of the data transmitted from the RTD located at the data center may have a recording device at the home station to record the data and a device for display of the data. The data may be a movie, a picture, a sound recording (music) or a document. The user would have a monitor or television set to display the movie, picture, or the document, a printer to print the document and an audio system to play voice and music which is transmitted from the RTD device.

The RTD would have a program to keep an inventory of all data held in memory. The program would have a method of identifying and indexing the data so that the user can find and select the data that they want to use at any time. This information is updated as each recording is made at the RTD.

The owner of copyright material who sends data can require certain criteria with respect to the hardware and software for the recording transmission device which would monitor and supervise the recording and transmission of data to make certain that the transmission of data is done in accordance with the contract with the owner of the copyright. The contract will stipulate how the recording may be used, and whether it is agreed that the data will not be broadcast or distributed in any way by the owner of the RTD except with the copyright owner's permission.

The data center where the recording device is located could participate in such monitoring, as may be required. The cost of monitoring the contract with the copyright owner may be shared by the many recording units which are located in the same facility. Some owners of copywritten matter may permit the transmission of the material through the recorder/transmission device with either complete copies, or only partial copies or samples of the material.

The recorder/transmission device may include a hardware device/software program that would cause the device to abide by the agreement made with the owner of the copyright.

For example the instructions may provide that the RTD store the data and transmit it only one time. The instructions may also provide that data may only be transmitted to designated approved recipients. The designation may be included in the contract between the designated sole recipient and the owner of the copyright. Enforcement of the contract may be facilitated for the copyright owners by the management of the data center supplying the copyright owners with a copy of the obligations of the data center and the sole recipient of the RTD.

Data may be sent to the RTD by direct arrangement made by the recipient (beneficiary) of material (data) with the various copyright owners. The recipient of data from the RTD may arrange that certain broadcast material (such as television or radio programs) may be recorded by the RTD. This arrangement may take place while the material is being broadcast or in advance of such broadcast by transmission of an encrypted signal deciphered to provide consent to transmission of associated programming.

The remote RTD is intended to give the user the same rights that the user had for such a device in the user's home but with a lower cost, and a higher level of preventative redundancy regarding the equipment.

The management of the data center may negotiate the right to make recordings for a fee. The data center can monitor the data sent to the RTD so that only permitted recordings are made and the proper payment, if any, is calculated, charged and collected.

The user may from a remote location control the recording transmission device with respect to the following:
1. Display of inventory of recording
   a) alphabetically by title,
   b) by subject matter alphabetically, and
   c) if a movie, alphabetically by the leading actor's name.
2. Enter instructions with respect to recordings to be made.
3. Display a synopsis of designated stored data if requested by title of a movie or file name.
4. Give an accounting of payments agreed to and paid for use of the RTD.
5. Cause the RTD to transmit selected data to the user.
6. Schedule future recordings.
7. Transmit to the user programs being broadcast in real time.

The customer can purchase (own) a section on a data center storage device and thereby gain access to more data.

The customer can access the RTD, i.e. send data to that storage device and receive data from it.

The customer can permit another party to send data to their storage device and may send data to another party, if the data being sent is not protected by copyright or in the instance where there is a copyright, obtain prior approval by the copyright owner for sending the data.

Accordingly it is an object of the present invention to provide a remote recorder/transmitter device which can record and transmit authorized copyright material to a remote user.

It is another object of the present invention to provide a housing for a remotely located recorder/transmitter device that records authorized copyright protected work and transmits the work after encryption and insertion of a secret code to a remote user.

It is another object of the present invention to provide a housing for a remotely located recorder/transmitter device that records authorized copyright protected work and transmits the work after encryption and insertion of a secret code to a remote user where the housing includes a backup power supply including a generator and an uninterruptible power supply.

It is still yet another object of the present invention to provide a housing for a remotely located recorder/transmitter device that records authorized copyright protected work and transmits the work after encryption and insertion of a secret code to a remote user where the housing includes a backup power supply including a generator and an uninterruptible power supply and the housing includes air conditioning and monitoring equipment to ensure continuous availability of the recorder/transmitter device.

These and other objects of the invention, as well as many of the intended advantages thereof, will become more readily apparent when reference is made to the following description taken in conjunction with the accompanying drawings.

### BRIEF DESCRIPTION OF THE DRAWING

The FIGURE schematically illustrates the operation of the housing including the recorder/transmitter device.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

With reference to the drawing, in general, a housing for a remote recorder/transmitter device is shown embodying the teachings of the subject invention. With reference to its orientation in the FIGURE, the housing or data center 10, provides a remote, secure location for housing of a recorder/transmitter device 12.

The data center is temperature controlled by an air conditioning/heating unit 14. The temperature as well as the status of all equipment contained in the data center 10 is monitored by monitoring equipment 16. If a power failure is detected, backup power supply 18, including a generator 20 and/ or an uninterruptible power supply 22 will be actuated for continuous power supply to the recorder/transmitter device.

Control of the recorder/transmitter device by an end user is made by an external telephone connection 24 or internet connection 26 to a computer 28. The computer 28, once receiving copyright authorization 30 from the copyright owner 8, is enabled to release data to the recorder/transmitter device.

Based upon an instruction received from telephone 24 or internet 26, the computer authorizes the recorder/transmitter device to transmit data 32 previously recorded, after the data is allowed to pass through a firewall 34 and a virus scan 36. The data may have a code insertion 38 for tracking of the data and may also be encrypted at encryption station 40 for decryption at the end user's home.

The foregoing description should be considered as illustrative only of the principles of the invention. Since numerous modifications and changes will readily occur to those skilled in the art, it is most desired to limit the invention to the exact construction and operation shown and described, and accordingly, all suitable modifications and equivalents may be resorted to, falling within the scope of the invention.

I claim:

1. A method of transferring data, said method comprising the steps of:
locating a recorder/transmitter device remotely from a user,
transferring data to the recorder/transmitter device,
storing the data in the recorder/transmitter device, and
transferring the data from the recorder/transmitter device to the user upon demand by the user.

2. The method of claim 1, wherein the data is protected by copyright.

3. The method of claim 2, wherein permission of the owner of the copyright has been obtained prior to transfer of the data to the recorder/transmitter device.

4. The method of claim 3, wherein the data transferred to the user is encrypted.

5. The method of claim 4, wherein the data transferred to the user includes a code identifying a source of the data.

6. The method of claim 1, wherein the recorder/transmitter device is located in a data center.

7. The method of claim 6, wherein the data center includes a backup power supply.

8. The method of claim 1, wherein the user communicates with the recorder/transmitter device by one of telephone and internet by way of a computer.

9. The method of claim 8, wherein the computer allows the recorder/transmitter device to transfer the data to the user upon the demand of the user.

10. The method of claim 3, wherein the permission of the owner of the copyright is obtained from a location remote from the recorder/transmitter device.
